(19) United States
(12) Patent Application Publication
(10) Pub. No.: US 2025/0148371 A1
(43) Pub. Date: May 8, 2025

(54) ESTIMATION OF OVERFITTING IN A MODEL OF A COMPUTER-BASED MACHINE LEARNING MODULE ON A TEST DATASET

(71) Applicant: Robert Bosch GmbH, Stuttgart (DE)

(72) Inventor: Alexander Hirsch, Muenchen (DE)

(21) Appl. No.: 18/937,315

(22) Filed: Nov. 5, 2024

(30) Foreign Application Priority Data
Nov. 8, 2023 (DE) 10 2023 211 077.6

(51) Int. Cl. G06N 20/00

(52) U.S. Cl. CPC G06N 20/00

(57) ABSTRACT

A method for validating a test data set for a computer-based machine learning module that contains at least one model. The method includes receiving first and second test data sets for the at least one model; calculating a degree of overutilization of the first test data set using the second test data set, wherein the degree of overutilization characterizes whether the first test data set is useful for evaluating the performance of the at least one model; classifying the first test data set as suitable for the subsequent evaluation of the at least one model if the degree of overutilization of the first test data set satisfies a predefined data set criterion, and otherwise, classifying the first test data set as not suitable for the subsequent evaluation of the at least one model.

### FIELD

The present invention relates to techniques for validating a test data set for a computer-based machine learning module. Related aspects relate to a method for evaluating a computer-based machine learning module, to a method for applying a computer-based machine learning module, to a computer program, and to a computer-implemented system.

### BACKGROUND INFORMATION

Computer-based machine learning modules are increasingly being used in various technical devices. In many cases, computer-based machine learning modules (e.g., those that use models such as artificial neural networks) must be extensively trained and tested on known data sets in order to provide plausible output data (i.e., unknown output data) for any given input data of a device. However, the use of such models in safety-critical applications (e.g., in the context of autonomous or assisted driving) is limited, because if the machine learning module operates on different data sets than those on which it was tested, some of the existing related art methods can produce unexpected (e.g., incorrect) results. The reason for this may be that in some cases the same test data sets are used multiple times to evaluate the same model of a machine learning module, and decisions for further development of the model can be made based on the test result. However, this corresponds to an implicit optimization on these test data sets, which can lead to what is known as “overfitting” in the model and consequently to a deterioration in the performance of the model on the new (unseen) data sets. The one-time use of test data sets cannot be proposed as a solution variant in some existing related art methods due to the lack of collected data. Therefore, despite the risk mentioned, it may be necessary to use the same test data sets for further development of the model in order to achieve the improved performance of this machine learning module model on the new data sets.

Therefore, there is a need to develop new techniques for validating test data sets for a computer-based machine learning module that can solve some or all of the above problems.

### SUMMARY

A first general aspect of the present invention relates to a method for validating a test data set for a computer-based machine learning module that contains at least one model. According to an example embodiment of the present invention, the method comprises receiving a first test data set and a second test data set for the at least one model. One or more data points of the first test data set of the first aspect were used at least once to evaluate the at least one model and no data point of the second test data set was used to evaluate the at least one model. The method further comprises calculating a degree of overutilization of the first test data set using the second test data set for the at least one model, wherein the degree of overutilization characterizes whether the first test data set is useful for evaluating the performance of the at least one model. Finally, the method comprises classifying the first test data set as suitable for the subsequent evaluation of the at least one model if the degree of overutilization of the first test data set satisfies a predefined data set criterion, and otherwise, if the degree of overutilization of the first test data set does not satisfy the predefined data set criterion, the method comprises classifying the first test data set as not suitable for the subsequent evaluation of the at least one model.

A second general aspect of the present invention relates to a method for evaluating a computer-based machine learning module that contains at least one model. According to an example embodiment of the present invention, the method of the second aspect comprises receiving a first test data set classified as suitable for subsequent evaluation of the at least one model according to the first aspect. Furthermore, the method of the second aspect comprises evaluating the at least one model of the computer-based machine learning module with the received first test data set to obtain an evaluated machine learning module. Subsequently, the method comprises classifying the evaluated machine learning module as suitable for use if an evaluation result of the at least one model satisfies a predefined evaluation criterion, and otherwise, if an evaluation result of the at least one model does not satisfy the predefined evaluation criterion, the method comprises classifying the evaluated machine learning module as not suitable for use.

A third general aspect of the present invention relates to a method for using a computer-based machine learning module that contains at least one model. According to an example embodiment of the present invention, the method of the third aspect comprises receiving a machine learning module evaluated according to the second aspect. The method also comprises processing application data by the received machine learning module if the evaluated machine learning module is classified as suitable for use.

A fourth general aspect of the present invention relates to a computer program that is designed to execute the method of the present invention.

A fifth general aspect of the present invention relates to a computer-implemented system that is designed to execute the methods (e.g., computer-implemented methods) according to one of the first to third general aspects and/or the computer program according to the fourth general aspect.

The techniques of the first to fifth general aspects can have one or more of the following advantages.

First, the techniques of the present invention can, in some cases, be used to verify whether test data sets that have already been used for a computer-based machine learning module (e.g., for its models) can be reused for the machine learning module (e.g., for further evaluation of its models, which in some cases may include further development thereof). Based on a characteristic that describes a test data set in its entirety (“degree of overutilization of the test data set,” see discussions below), it can be concluded in some cases of the present techniques that the test data sets can or cannot be reused for the same machine learning module. This can, in some cases, avoid situations where the machine learning module is evaluated on unsuitable test data sets (which in some cases may also mean further development of the model) and then used in a device where it may not perform satisfactorily.

Second, the techniques of the present invention can make it possible for the suitable test data sets already seen by a machine learning module to be reused by the same machine learning module (e.g. to evaluate its models), whereby higher performance of the models of the machine learning module can be achieved.

Third, compared to some related art techniques, the present techniques offer the possibility of achieving the desired performance of the machine learning modules despite the limited amount of available data.

Some terms are used in the present disclosure in the following way:

The term “computer-based machine learning module” in the present disclosure means any device that can be or has been trained for one or more tasks using machine learning. During training, “training data sets” may be provided to the computer-based machine learning module as input data, and the properties (e.g. corresponding parameters) of the computer-based machine learning module can be adapted in response to processing the training data sets (e.g. by analyzing the output data) to solve the one or more tasks in a defined manner (e.g. with a certain accuracy). A computer-based machine learning module can contain a model (or multiple models) that can be parameterized. Adapting the properties of the machine learning module during learning can be done, for example, by means of an optimization procedure with respect to (unknown) parameters of the machine learning module (e.g. a corresponding model), which can be represented as minimization of a loss function (within a predefined numerical accuracy and/or until a predefined termination criterion is reached). The adapted machine learning module can then be used to predict the responses for the observations in another data set referred to as the “test data set”; for example, the test data set can provide an evaluation of a machine learning module model (e.g. the performance evaluation of that model) that was trained using a training data set (or a plurality of training data sets). In addition, the test data sets can be used once (e.g. if they have not been used previously to evaluate the model, in other words, have not been seen by the model) or multiple times (e.g. if they have been seen previously by the model) for the same model. Furthermore, in some cases, a “test data set” of the present disclosure can be used in the development of the model (after its training/validation has been completed) so that one or more adjustments can be made (or have already been made) in this model based on the evaluation result, more on this below. In some cases, the machine learning module can also contain one or more models that do not use machine learning, but that can be trained and evaluated in a similar way to a model that uses machine learning (compared to the latter, a model that does not use machine learning can be modified only slightly in the respective training iterations in the optimization procedure).

In some cases, “a computer-based machine learning module” can perform a classification task or a regression task. As a non-limiting example, the computer-based machine learning module (e.g. its model) can comprise an artificial neural network having a particular topology and a number of neurons with corresponding connections. According to some embodiments, the neural network can be a convolutional neural network (CNN for short) that is defined, for example, by the number of filters, filter sizes, step sizes, etc. A convolutional neural network can, for example, be used for the purpose of image classification and perform one or more transformations on digital images based on, for example, convolution, nonlinearity (ReLU), pooling or classification operations (e.g. using fully connected layers). The neural network can also be designed as a multilayer feedforward or recurrent network, as a neural network with direct or indirect feedback, or as a multilayer perceptron. The machine learning modules based on neural networks can be used in a vehicle computer or another component of a vehicle or in an at least partially autonomous robot (e.g. to evaluate an operating state of the vehicle or robot and/or to control a function of the vehicle or robot based on state and/or environmental data of the vehicle or robot as input data). For example, computer-based machine learning modules can be implemented in any suitable form, i.e. in software, in dedicated hardware, or in a hybrid of software and dedicated hardware. Therefore, the computer-based machine learning modules can be a software module (also integrated into a higher-level software system) that can run on a general-purpose processor. In other cases, a computer-based machine learning module can be (at least partially) implemented in circuitry.

The term “training data set” in the present disclosure means a collection of a plurality of data that is selected and used to train a computer-based machine learning module. The data of the training data set are referred to as “data points” below. Depending on the nature of the task for which a computer-based machine learning module is used, the data points of a training data set may contain different information. For example, each data point in a training data set with image data can contain a single image (or a section thereof) or a video. For example, an image element can contain a number of image pixels (e.g. 1024×2048 pixels), wherein each image pixel has a number of color values (e.g. three color values with 16 bit color depth). In some cases, the images can contain features that are processed by a model of the computer-based machine learning module (e.g. a model that comprises a neural network, as described above). In the example of a vehicle-integrated sensor system, features on the images are possible in connection with street scenes recorded on them with one or more objects such as traffic signs, lanes or other road or pedestrian zone markings, trees, buildings, road users such as pedestrians, cyclists or other vehicles. In other examples, “data points” of a training data set can contain data series (e.g., time series).

Accordingly, the term “test data set” encompasses a collection of a plurality of data that is selected and used to evaluate a computer-based machine learning module (e.g., one or more of its models in the sense mentioned above). The test data sets can have the same nature (e.g., structure and/or format) as the training data sets used for the same machine learning model. As described above, the “test data set” can be used to evaluate (or in other words, test) a trained model of the machine learning module (once or several times). In some cases, one or more adjustments/changes can be made to the trained model in response to the evaluation result that, for example, the performance of the model does not satisfy a criterion (e.g., the proportion of correct predictions of an image classifier is less than a predefined threshold). Returning to the example with the images: If the test data set shows that the model has a weakness with respect to a certain type of (input) images, such as a low performance in the sense described above when detecting features in the images (e.g. pedestrians in the rain), this information can be taken into account when further developing the trained model, for example by adding more images with these specific features (e.g. images with rain and pedestrians) to a training set in order to further train and thus improve the model based on this augmented training set.

Alternatively or additionally, it is possible within the scope of the present invention that one or more so-called hyperparameters of a model of the machine learning module can be changed based on the evaluation result obtained from the test data set. In this context, hyperparameters can be understood as the parameters of the model that cannot be adjusted directly based on the training data set during an optimization procedure and can be set before training, for example the number of nodes of a neural network. In some cases, the input data fed to the machine learning module (e.g. the data points introduced above) and/or the output data read by the machine learning module (e.g. for further application) can be adjusted accordingly based on the evaluation result (and/or the respective interfaces of the machine learning module designed to receive the input data or to send the output data can be adjusted). Returning to the example with the images: If the test data set shows that the model processes/interprets the features of images in reverse form, this information can be used to feed the images into the machine learning module (e.g. its model) accordingly in the future.

On the other hand, a “test data set” within the meaning of the present invention is not directly used to train the model, which may typically include a plurality of iteration steps in the optimization process during training; thus, a “test data set” differs from a “training data set” within the meaning of the present disclosure. As described above, the same test data set can be used one or more times for the same model of the computer-based machine learning module. However, in some cases, reusing a test data set for the same model and then adapting the model based on the evaluation result of this test data set (e.g. the type of information provided by the evaluation result) can lead to overfitting. The latter can usually degrade the performance of the model in the sense that this model can make accurate predictions for this test data set, but not for new data sets that have not been seen.

Accordingly, a “degree of overutilization of the test data set” can characterize whether the same test data set is still usable for the model (e.g. for its further evaluations/adaptations based on this data set) if it (e.g. the entire test data set or one or more of its data points) has already been used for one or more adaptations of the model. In some cases, an “extent of use” of a data point used to evaluate/adapt the model (i.e. previously seen in the model) can contain categories (in other words, be categorized): These “categories” can, for example, describe the extent to which the information contained in this data point has changed the model during its further development. In addition, the “extent of use” can contain information about a number of uses of this data point in the categories, more on this below. In this way, for example, the categories can be assigned to more than one seen data point (e.g. all seen data points of the test data set).

The aforementioned performance of a model of the computer-based machine learning module can be quantified below by a “performance metric” with respect to a data set (e.g. a test data set). The “performance metric” can be, for example, the accuracy of the model, which in the case of a classification task can be defined as the ratio of correct predictions to the total number of predictions. The other performance metrics such as precision, recall, F₁ score, or any other performance metric are also possible within the scope of the present invention. In some cases, a “performance metric” can comprise any combination of the performance metrics listed above; in other words, the performance metric can represent an overall characteristic that can be calculated, for example, as a weighted sum of the individual performance metrics.

The term “vehicle” comprises any apparatus designed for the transportation of passengers and/or cargo. The vehicle can be a motor vehicle (for example, an at least partially autonomously operating/assisted motor vehicle, in particular a car or a truck). However, the vehicle can also be a ship, a train, an aircraft, or a spacecraft.

### BRIEF DESCRIPTION OF THE DRAWINGS

FIG. 1A is a flow chart showing an example of a method for validating a test data set for a computer-based machine learning module according to the first aspect of the present invention.

FIG. 1B is a flow chart showing further possible method steps according to the first aspect of the present invention.

FIG. 1C is a flowchart showing an example of a method for evaluating a computer-based machine learning module according to the second aspect of the present invention.

FIG. 1D is a flowchart showing an example of a method for using a computer-based machine learning module according to the third aspect of the present invention.

### DETAILED DESCRIPTION OF EXAMPLE EMBODIMENTS

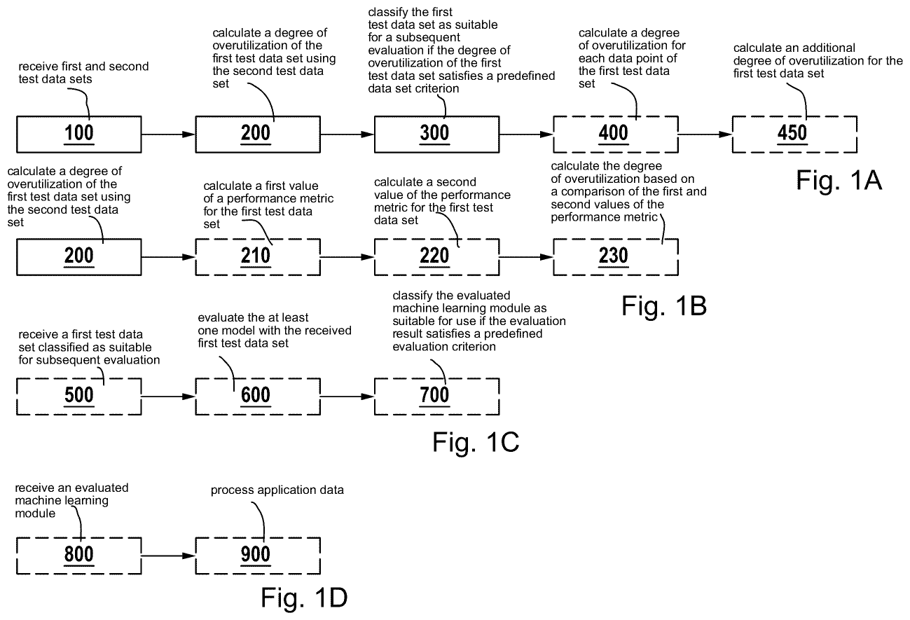

First, techniques for validating a test data set for a computer-based machine learning module according to the first aspect are described with reference to FIGS. 1A and 1B. Subsequently, techniques for evaluating a computer-based machine learning module according to the second aspect are presented with reference to FIG. 1C. Next, techniques for applying a computer-based machine learning module according to the third aspect are described with reference to FIG. 1D. The method steps are shown in the boxes drawn by solid lines in FIG. 1A to 1D, while the method steps of further features are shown in the boxes represented by dashed lines.

As outlined in FIG. 1A, a first general aspect concerns a method (e.g. a computer-implemented method) for validating a test data set for a computer-based machine learning module that contains at least one model (e.g. one model or more, two models or more, five models or more, ten models or more). The model can, for example, comprise an artificial neural network (e.g. a CNN). As described above, the model can be trained first before checking (using this model) whether the test data set is still useful for this model (e.g., if the same test data set has already been seen in this model in the sense described above). For example, the model can first be trained using a training data set (see discussions above). In some cases, the model can be additionally validated (e.g. using a validation set, which may have the same nature as a training set) after the training phase but before the testing phase (i.e. before test data sets are used for the model). In the present disclosure, in some cases no boundary is drawn between the training phase and the validation phase of the model. Therefore, in the following, the trained model with or without subsequent validation is referred to as the trained model.

The first step of the method comprises receiving 100 a first test data set and a second test data set for the at least one model, wherein one or more data points of the first test data set (e.g. all data points of the first test data set) were used at least once to evaluate (e.g. to evaluate the performance of) the at least one model and no data point of the second test data set was used to evaluate the at least one model. In other words, the first data set has already been seen by this model (through the one or more seen data points of the first data set), while the second data set has never been seen by the model.

The present techniques further comprise calculating 200 a degree of overutilization of the first test data set using the second test data set for the at least one model. (If the machine learning module comprises more than one model, the degree of overutilization of the first test data set can be calculated for each model, for example.) In this case, the degree of overutilization characterizes whether the first test data set is useful for evaluating the performance of at least one model. As explained above, in some cases, one or more adjustments (in other words, changes) can be made to the model (e.g., the trained model) on the basis of an evaluation result obtained using the first data set (i.e. the model can be further developed based on the evaluation result). Therefore, in some cases, the (expected) performance of the model in its intended use environment may deteriorate due to overfitting, for example immediately after the first use of the first test data set, after the second use of the first test data set, after the third or any other subsequent use of the first test data set. This means that the performance measured using the first test data set may increase after the first use (or another subsequent use) of the first test data set and thus can no longer meaningfully describe the (realistic) performance in the intended use environment of the model. In other words, this model can provide accurate predictions for the first test data set, but not for new, unseen test data sets.

The next step of the method comprises classifying 300 the first test data set as suitable for the subsequent evaluation of the at least one model if the degree of overutilization of the first test data set satisfies a predefined data set criterion. In this case, the same (first) test data set may still be useful for the model (e.g. for its further evaluations/adaptations or for another statement about the model based on this data set). Otherwise, if the degree of overutilization of the first test data set does not satisfy the predefined data set criterion, the method comprises classifying the first test data set as not suitable for subsequent evaluation of the at least one model. In this case, the same (first) test data set can no longer be used for the model in the sense described above; the first test data set can then either be put aside or, as explained below, modified accordingly so that it can be used again for the model.

In the techniques of the present invention, calculating the degree of overutilization of the first test data set can comprise calculating 210 a first value of a performance metric “P₁” (e.g., as introduced above, an accuracy, a precision, a recall, an F₁ score, or other performance metric) for the first test data set (in other words, with respect to the test data set already seen). In addition, the method can comprise calculating 220 a second value of the performance metric “P₂” for the second test data set (in other words, with respect to the test data set not seen by the model). Subsequently, the degree of overutilization of the first test data set can be calculated 230 on the basis of a comparison of the first and second values of the performance metric.

Furthermore, the method step of “calculating 230” the degree of overutilization on the basis of the comparison of the first and second values of the performance metric can comprise determining a deviation between the first and second values of the performance metric, wherein the degree of overutilization is equal to the deviation. In one case, the deviation can be proportional to a difference between the first and second values of the performance metric divided by the second value of the performance metric. For example, the weighted deviation can be written as follows: α·(P₁−P₂)/P₂, where α>0 is a coefficient. (In this case P₁ denotes the first value of the performance metric for the first test data set and P₂ denotes the second value of the performance metric for the second test data set.) In an example of α=1, the deviation can be defined as follows: (P₁−P₂)/P₂. Alternatively, the deviation can be proportional to a difference between the first and second values of the performance metric divided by the first value of the performance metric. For example, the deviation can be written as follows: β·(P₁−P₂)/P₁, where β>0 is a coefficient. In an example of β=1, the deviation can be defined as follows: (P₁−P₂)/P₁. In some cases, P₁ may take a value greater than P₂, P₁>P₂ (and thus the deviation is positive) because the performance of the model on the first test data set (the test data set that is seen) can be greater than the performance of the model on the second test data set (the test data set that is not seen) due to possible overfitting in the model (e.g. caused by the previous use of the first test data set in the sense described above).

In the techniques of the present invention, the predefined data set criteria can comprise the fact that the degree of overutilization of the first test data set falls below a predefined threshold. For example, if the degree of overutilization, which is equal to the deviation between the first and second values of the performance metric introduced above, falls below a predefined threshold (i.e. the predefined data set criterion is satisfied), the first test data set can be classified as suitable for subsequent evaluation of the model. Otherwise, if the degree of overutilization of the first test data set, which is equal to the deviation between the first and second values of the performance metric, is above the predefined threshold (i.e. the predefined data set criterion is not satisfied), the first test data set can be classified as unsuitable for subsequent evaluation of the model.

In the example introduced above, if the degree of overutilization is given as a ratio (P₁−P₂)/P₂, the strongly differing values of P₁ and P₂ (in the sense that the ratio (P₁−P₂)/P₂ is above the predefined threshold) may indicate that the model has overfitting due to the further development already carried out on the basis of the first test data set (e.g. the adjustments made in this model). In this situation, the first data set can no longer be used for the model (e.g. without possible modification, as described in more detail below). Conversely, when the values P₁ and P₂ do not differ greatly from each other (in the sense that the ratio (P₁−P₂)/P₂ falls below a predefined threshold), the first test data set can be used again to evaluate the model. For example, the zero ratio (P₁−P₂)/P₂=0 (within a predefined numerical precision) can describe a situation where previous development of the model using the first test data set had no noticeable effect on the model (i.e. the first test data set can be re-used for the model). In a non-limiting example, the threshold can be 0.05 or greater, 0.1 or greater, 0.25 or greater, 0.5 or greater.

It should be noted that in some cases the predefined data set criterion can be defined differently, for example the predefined data set criterion can comprise the fact that the degree of overutilization of the first test data set is above a predefined threshold. (In this case, the degree of overutilization of the first test data set can also be defined accordingly.)

The techniques of the present invention can further comprise iteratively adding one or more data points from the second test data set (i.e. the data set that the model has not seen) to the first test data set (i.e. the data set that the model has already seen) if the degree of overutilization of the first test data set does not satisfy the predefined data set criterion (examples of the predefined data set criterion are discussed in detail above). The method can then comprise calculating an updated performance metric with respect to the first test data set with the one or more added data points. Furthermore, the method can comprise calculating the updated degree of overutilization of the first test data set on the basis of the updated first performance metric and the second performance metrics (for example, the same value can be used for the second performance metric as before the data points were added to the first test data set). In addition, the one or more data points from the second test data set can be iteratively added to the first test data set until the updated degree of overutilization satisfies the predefined data set criterion. Now, in some cases, the first data set augmented in this way (with added data points) can be used again for the model (in the sense described above). The updated degree of overutilization (discussed above) can be calculated in the same way as already discussed for the degree of overutilization.

The method of the first aspect can comprise calculating a new first value of the performance metric with respect to the first test data set and/or a new second value of the performance metric with respect to the second test data set if the degree of overutilization calculated on the basis of the first and second performance metrics satisfies a predefined second data set criterion. In some cases, the predefined second data set criterion can be satisfied if, for example, the first and/or second test data set does not contain enough data points to draw statistically reliable conclusions. Alternatively or additionally, the predefined second data set criterion can be satisfied if, for example, the first and second test data sets come from different statistical distributions. (Other causes within the scope of this invention are also possible.) For example, the predefined second data set criterion can comprise the fact that the degree of overutilization of the first test data set falls below a predefined second threshold. Returning to the example in which the degree of overutilization is given as a ratio (P₁−P₂)/P₂: In this case, for example, the zero ratio (P₁−P₂)/P₂=0 (within a predefined numerical precision) can be selected as the predefined second threshold (as discussed above, in some cases it is expected that P₁ can take a value greater than P₂, P₁>P₂).

In addition, calculating the new first performance metric with respect to the first test data set can comprise expanding a confidence interval with respect to the first test data set (e.g. using a bootstrapping procedure, see e.g. https://www.sciencedirect.com/topics/mathematics/bootstrap-confidence-interval for further details). Alternatively or additionally, calculating the new second performance metrics with respect to the second test data set can comprise expanding a confidence interval with respect to the second test data set. After this action, it may happen in some cases that the degree of overutilization calculated on the basis of the new first performance metric and/or the new second performance metric does not satisfy the predefined second data set criterion (in the above example, P₁ can be greater than P₂, P₁>P₂, as originally expected).

It should be noted that the predefined second data set criterion can in some cases be defined differently (as already explained in connection with the predefined second data set criterion), for example the predefined second data set criterion can comprise the fact that the degree of overutilization of the first test data set is above a predefined second threshold. (In this case, the degree of overutilization of the first test data set can also be defined accordingly.)

Furthermore, in the present techniques, each data point of one or more data points of the first test data set can be associated with metainformation that characterizes an extent of use of this data point in a previous development of the at least one model (the “extent of use” is defined above). Additionally, the method can further comprise calculating 400 a degree of overutilization for each data point of the one or more data points of the first test data set using the metainformation associated with this data point. In other words, it can be the one or more data points from the first test data set that have already been seen by the model (or, for example, a plurality of models if there is more than one model in the computer-based machine learning module). The metainformation associated with the (seen) data point of the first test data set can be part of the data point or stored separately from the data point.

The extent of use of the data point (e.g. each data point that has been seen) in the present techniques can comprise classification into one or more categories (e.g. one, two or more, three or more, four or more, ten or more categories) reflecting the extent of use of the data point. Furthermore, the extent of use of the data point can comprise information regarding a number of uses of the data point in each category of the one or more categories in the previous development of the at least one model. In the present techniques, a predetermined factor can be assigned to each of the one or more categories. In addition, the degree of overutilization of the data point can be a function of the predetermined factor of each category and the number of uses of the data point in this category. In this case, calculating 400 the degree of overutilization of the data point can comprise calculating this function.

Such a categorization can be illustrated, for example, in the context of adjusting parameters of the model and the hyperparameters of the model based on the evaluation result using the first test data set, see the definition of the term “test data set” above. For example, the (further) development of the trained model (which was originally trained with a training data set) can have been retrained with additional images containing these image features for the purpose of improving its performance in recognizing one or more image features (in this case, for example, one or more parameters of this trained model can be further adjusted). This further development of the trained model can be attributed to the first category, K₁, which is described by a first factor, F₁. In another example, the further development of the trained model in the same context can mean an adjustment of one or more hyperparameters; this refinement can be classified into the second category, K₂ to which is a second factor, F₂, is assigned. In another example, an additional test may have been performed on the model based on the evaluation result using a data point from the first test data set. If the model passes this additional test, no further training of the model is required, for example. This can be the third category, K₃, which is described by the third factor, F₃.

As a non-limiting example, the categories can be arranged in ascending order according to the strength of their influence on the development of the model (in other words, how much the model is changed when the actions associated with the category are performed). In this case, the predetermined factor of a lower category (i.e. a more important category according to the non-limiting definition above) can be greater than or equal to the predetermined factor of a subsequent higher category (i.e. a less important category according to the definition above). In the example shown in the above paragraph, the three categories, Kᵢ (i=1, 2, 3), are arranged according to this definition. In addition, for example, the following relation can apply to three factors of these categories: F₁≥F₂≥F₃. For the L existing categories, Kᵢ (i=1, . . . , L), where L is any natural number, the above discussion can be generalized as follows: F₁≥F₂≥ . . . ≥F_{L}. In some cases, the values for the predetermined factors can be set depending on the model under consideration or other influencing factors (e.g. by a user) or adjusted automatically (i.e. without user intervention).

In the present invention, the degree of overutilization of the data point can be proportional to the product of the predetermined factor of the category and the number of uses of the data point in this category if only one category is present in the one or more categories. In another case, if more than one category is present in the one or more categories, the degree of overutilization of the data point can be proportional to a sum of the respective products of the predetermined factor of each category and the number of uses of the data point in this category. In one example, a proportionality factor can be equal to one. For example, the degree of overutilization of the data point, VGrad, for the L existing categories, Kᵢ (i=1, . . . , L), can be calculated as VGrad=Σᵢ₌₁^{L}Aᵢ·Fᵢ where Aᵢ describes the number of uses in an i-th category, Kᵢ, and Fᵢ is assigned to the predetermined factor that corresponds to category Kᵢ.

Furthermore, the method can comprise calculating 450 an additional degree of overutilization of the first test data set. The additional degree of overutilization of the first test data set can be proportional to the degree of overutilization of the data point from the one or more data points of the first test data set if only one data point is present in the one or more data points. In another case, if there is more than one data point in the one or more data points, the additional degree of overutilization of the first test data set can be proportional to a sum of all degrees of overutilization of the data points from the one or more data points of the first test data set. In one example, a proportionality factor can be equal to one. In another example, the additional degree of overutilization of the first test data set can be normalized to a number of data points of the one or more data points of the first test data set. For example, the additional degree of overutilization “VZus” for M data points can be written as follows: VZus=1/M·Σᵢ₌₁^{M} where VGradₗ is the degree of overutilization of the l-th data point.

Furthermore, the predefined data set criteria of the present invention can comprise the fact that the degree of overutilization of the first test data set falls below a predefined threshold and the additional degree of overutilization of the first test data set falls below an additional predefined threshold. In some cases, the selection of additional predefined thresholds can be done in a similar way as explained in detail above in connection with the predefined threshold. The additional degree of overutilization of the first test data set can therefore serve as an additional measure for classifying the first test data set as suitable or unsuitable for subsequent evaluation of the at least one model.

Furthermore, the method of the first aspect can comprise selecting a model of the machine learning module of which the degree of overutilization of the first test data set and/or the additional degree of overutilization of the first test data set is below a predefined selection threshold if the computer-based machine learning module contains more than one model. For example, the predefined selection threshold can be smaller than the previously introduced predefined threshold and/or the additional predefined threshold. In this way, for example, one or more models can be selected whose subsequent evaluation with the first test data set is most useful.

A second general aspect of the present invention relates to a method for evaluating a computer-based machine learning module that contains at least one model. The method of the second aspect comprises receiving 500 a first test data set classified as suitable for subsequent evaluation of the at least one model according to the first aspect. Furthermore, the method of the second aspect comprises evaluating 600 the at least one model of the computer-based machine learning module with the received first test data set to obtain an evaluated machine learning module. Subsequently, the method comprises classifying 700 the evaluated machine learning module as suitable for use if an evaluation result of the at least one model satisfies a predefined evaluation criterion, and otherwise, if an evaluation result of the at least one model does not satisfy the predefined evaluation criterion, the method comprises classifying the evaluated machine learning module as not suitable for use.

For example, the predefined evaluation criterion can comprise the fact that a performance metric of the model (calculated using the received first test data set that was classified as suitable for subsequently evaluating the at least one model according to the first aspect) is above the predefined threshold. In this case, this may mean that the performance of the model is sufficient to use this model in an application. (This predefined evaluation criterion can also be applied to other existing models of the machine learning module.)

Furthermore, the method of the second aspect can comprise updating the at least one model of the one computer-based machine learning module using the first test data set (which has been classified as suitable for subsequently evaluating the at least one model according to the first aspect) based on the evaluation result. For example, updating the at least one model can comprise adjusting the at least one model (in the sense described above) if the evaluation result of the at least one model does not satisfy the predefined evaluation criterion.

A third general aspect of the present invention relates to a method for using a computer-based machine learning module that contains at least one model. The method of the third aspect comprises receiving 800 a machine learning module evaluated according to the second aspect. The method also comprises processing 900 application data by the received machine learning module if the evaluated machine learning module is classified as suitable for use.

In the present techniques, the computer-based machine learning modules can be designed for a plurality of applications. In some cases, the computer-based machine learning module can be designed to process images. In this example, the corresponding test data sets according to the first to third aspects can contain image data (e.g. single image data or video data). The image data can be generated using various sensors (e.g. cameras, radar, lidar, ultrasonic or thermal sensors) and/or comprise synthetically generated image data. In some examples, the computer-based machine learning module can be an image classifier (e.g. an image classifier that semantically segments image data pixel-by-pixel or region-by-region). The image classifier can be configured to receive input data in the form of image data and classify it into multiple classes. In some examples, this can comprise mapping input data in the form of an input vector of one dimension (Rⁿ), which contains image data, to output data in the form of an output vector of a second dimension (R^{m}), which represents a classification result. For example, components of the input vector can represent a plurality of received image data. Each component of the output vector can represent an image classification result computed using the computer-based machine learning module of the present invention.

Alternatively or additionally, the computer-based machine learning module can be designed to process data series. In this case, the corresponding test data sets according to the first to third aspects can contain the data series (e.g. time series). The data series can be generated using various sensors (e.g. cameras, radar, lidar, ultrasonic or thermal sensors, sensors for controlling the engine of a vehicle).

In some examples, the above-mentioned image classification can comprise semantic segmentation of an image (e.g. region-by-region and/or pixel-by-pixel classification of the image). Image classification can be, for example, object classification. For example, the presence of one or more objects in the image data can be detected (e.g. road users such as pedestrians, cyclists or other vehicles in the context of autonomous driving or traffic signs or lanes in the context of assisted driving). In this case, the computer-based machine learning modules can be integrated into the vehicle system (e.g. systems for assisted or autonomous driving) to provide functionality for the vehicle.

In other examples, the computer-based machine learning module can be used for a monitoring task (e.g. a manufacturing process and/or quality assurance). For example, the computer-based machine learning module can be designed or used to monitor the operating state and/or environment of an at least partially autonomous robot. In some examples, the at least partially autonomous robot can be an industrial robot. In other examples, the computer-based machine learning module can be configured or used to monitor the operating state and/or environment of a machine (e.g. a machine tool) or a group of machines (e.g. an industrial site). In these examples, the input data can include state data of the at least partially autonomous robot, the machine or group of machines and/or their environment and the output data can include information regarding the operating state and/or the environment of the respective device.

In further examples, the computer-based machine learning module can be designed for a medical imaging system (e.g. for interpreting diagnostic data) or can be used in such a device.

In the present disclosure, a device (e.g. a vehicle, a robot, an industrial plant, a medical device, or a household appliance) can be monitored and/or controlled based on the classification result.

In further examples, the computer-based machine learning module can be designed or used to control (or regulate) a device. The device can in turn be one of the devices discussed above (e.g. a vehicle, an at least partially autonomous robot or a machine). In these examples, the input data can include state data of the device regarding an internal state of the device (e.g. at least some sensor data). Additionally or alternatively, the input data can include state data regarding the environment of the device (e.g. at least some sensor data). The output data of the computer-based machine learning module can characterize an operating state or other internal condition of the device (e.g. whether or not a fault, an anomaly, or a critical operating condition exists). The output data can be used to control the device in response to the characterized operating state or to another internal state. Alternatively or additionally, the output data can include control data for the device. In some examples, for example, the input vector of an image classifier (or a probabilistic regressor) can represent elements of a time series for at least one measured input state variable of the device. The output vector of the image classifier can represent at least one estimated output state variable of the device. In some examples, the machine can be an engine or motor (e.g. an internal combustion engine, an electric motor, or a hybrid engine). In other examples, the device can be a fuel cell. In one example, the measured input state variable of the device can comprise a rotational speed, a temperature, a mass flow, or any combination thereof. The estimated output state variable of the device can comprise, for example, a torque, an efficiency, a pressure ratio, or any combination thereof.

A fourth general aspect of the present invention relates to a computer program that is designed to execute the methods (e.g. computer-implemented methods) of the present invention. The present invention also relates to a computer-readable medium (for example, a machine-readable storage medium such as an optical storage medium or read-only memory, for example, FLASH memory) and signals that store or encode the computer program of the present invention.

A fifth general aspect of the present invention relates to a computer-implemented system that is designed to execute the methods (e.g. computer-implemented methods) according to one of the first to third general aspects and/or the computer program according to the fourth general aspect. The computer-implemented system can comprise at least one processor, at least one memory (which can contain programs that, if executed, perform the methods of the present invention) as well as at least one interface for inputs and outputs. The computer-implemented system can be a stand-alone system or a distributed system that communicates over a network (e.g. the Internet).

1-17. (canceled)

18. A method for validating a test data set for a computer-based machine learning module that includes at least one model, the method comprising the following steps:
receiving a first test data set and a second test data set for the at least one model, wherein one or more data points of the first test data set were used at least once to evaluate the at least one model and no data point of the second test data set was used to evaluate the at least one model;
calculating a degree of overutilization of the first test data set using the second test data set for the at least one model, wherein the degree of overutilization characterizes whether the first test data set is useful for evaluating the performance of the at least one model; and
classifying the first test data set as suitable for the subsequent evaluation of the at least one model when the degree of overutilization of the first test data set satisfies a predefined data set criterion, and otherwise, when the degree of overutilization of the first test data set does not satisfy the predefined data set criterion, classifying the first test data set as not suitable for the subsequent evaluation of the at least one model.

19. The method according to claim 18, wherein the predefined data set criterion includes that the degree of overutilization of the first test data set falls below a predefined threshold.

20. The method according to claim 18, wherein the calculating of the degree of overutilization of the first test data set includes:
calculating a first value of a performance metric for the first test data set;
calculating a second value of the performance metric for the second test data set; and
calculating the degree of overutilization of the first test data set based on a comparison of the first and second values of the performance metric.

21. The method of claim 20, wherein the calculating of the degree of overutilization on based on the comparison of the first and second values of the performance metric includes determining a deviation between the first and second values of the performance metric, wherein the degree of overutilization is equal to the deviation.

22. The method according claim 20, further comprising:
iteratively adding one or more data points from the second test data set to the first test data set when the degree of overutilization of the first test data set does not satisfy the predefined data set criterion;
calculating an updated performance metric with respect to the first test data set with the one or more added data points;
calculating the updated degree of overutilization of the first test data set on the basis of the updated first performance metric and the second performance metrics;
wherein the one or more data points from the second test data set are iteratively added to the first test data set until the updated degree of overutilization satisfies the predefined data set criterion.

23. The method according to claim 20, wherein each data point of one or more data points of the first test data set is associated with metainformation that characterizes an extent of use of the data point in a previous development of the at least one model, and wherein the method further comprises calculating a degree of overutilization for each data point of the one or more data points of the first test data set using the metainformation associated with the data point.

24. The method according to claim 23, wherein the extent of use of the data point includes the following: i) classification into one or more categories reflecting the extent of use of the data point, and ii) information regarding a number of uses of the data point in each category of the one or more categories in the previous development of the at least one model.

25. The method according to claim 24, wherein each category of the one or more categories is associated with a predetermined factor, wherein the degree of overutilization of the data point is a function of the predetermined factor of each category and the number of uses of the data point in this category, and wherein the calculating of the degree of overutilization of the data point includes calculating the function.

26. The method according to claim 25, wherein the degree of overutilization of the data point is proportional to a product of the predetermined factor of the category and a number of uses of the data point in the category when only one category is present in the one or more categories, and the degree of overutilization of the data point is proportional to a sum of the respective products of the predetermined factor of each category and the number of uses of the data point in the category when more than one category is present in the one or more categories.

27. The method according to claim 23, further comprising:
calculating an additional degree of overutilization of the first test data set, wherein the additional degree of overutilization of the first test data set is proportional to the degree of overutilization of the data point from the one or more data points of the first test data set when only one data point is present in the one or more data points, and the additional degree of overutilization of the first test data set is proportional to a sum of all degrees of overutilization of the data points from the one or more data points of the first test data set when more than one data point is present in the one or more data points.

28. The method according claim 10, wherein the predefined data set criterion comprises the fact that the degree of overutilization of the first test data set falls below a predefined threshold and the additional degree of overutilization of the first test data set falls below an additional predefined threshold.

29. The method according to claim 28, further comprising:
selecting a model of the machine learning module of which the degree of overutilization of the first test data set and/or the additional degree of overutilization of the first test data set is below a predefined selection threshold when the computer-based machine learning module contains more than one model.

30. The method according to claim 18, further comprising the following steps:
receiving the first test data set that has been classified as suitable for the subsequent evaluation of the at least one model;
evaluating the at least one model of the computer-based machine learning module with the received first test data set to obtain an evaluated machine learning module; and
classifying the evaluated machine learning module as suitable for use when an evaluation result of the at least one model satisfies a predefined evaluation criterion, and otherwise, if an evaluation result of the at least one model does not satisfy the predefined evaluation criterion, classifying the evaluated machine learning module as not suitable for use.

31. The method according to claim 30, further comprising:
receiving the evaluated machine learning module; and
processing application data using the received machine learning module when the evaluated machine learning module is classified as suitable for use.

32. The method according to claim 18, wherein the computer-based machine learning module is configured to:
(i) process images, wherein the first and second test data sets contain image data; and/or
(ii) process data series, wherein the first and second test data sets contain the data series.

33. A non-transitory computer-implemented system on which is stored a computer program configured to validate a test data set for a computer-based machine learning module that includes at least one model, the computer program, when executed by a computer, causing the computer to perform the following steps:
receiving a first test data set and a second test data set for the at least one model, wherein one or more data points of the first test data set were used at least once to evaluate the at least one model and no data point of the second test data set was used to evaluate the at least one model;
calculating a degree of overutilization of the first test data set using the second test data set for the at least one model, wherein the degree of overutilization characterizes whether the first test data set is useful for evaluating the performance of the at least one model; and
classifying the first test data set as suitable for the subsequent evaluation of the at least one model when the degree of overutilization of the first test data set satisfies a predefined data set criterion, and otherwise, when the degree of overutilization of the first test data set does not satisfy the predefined data set criterion, classifying the first test data set as not suitable for the subsequent evaluation of the at least one model.
